(19) United States
(12) Patent Application Publication
(10) Pub. No.: US 2025/0114766 A1
(43) Pub. Date: Apr. 10, 2025

(54) PLATE ELEMENT FOR REACTION MODULES OR SYSTEMS AND CORRESPONDING PROCESSES

(71) Applicants: INERATEC GmbH, Karlsruhe (DE); Karlsruhe Institute of Technology, Eggenstein-Leopoldshafen (DE)

(72) Inventors: Peter PFEIFER, Linkenheim-Hochstetten (DE); Sebastian SCHMIDT, Karlsruhe (DE); Alexander PFAFF, Karlsruhe (DE); Florian BETZNER, Karlsruhe (DK)

(21) Appl. No.: 18/683,464

(22) PCT Filed: Aug. 11, 2022
(86) PCT No.: PCT/EP2022/072543

§ 371 Date: Sep. 16, 2024

(30) Foreign Application Priority Data
Aug. 13, 2021 (DE) 10 2021 208 923.2

(51) Int. Cl. B01J 19/24

(52) U.S. Cl. CPC B01J 19/249; B01J 2219/00076; B01J 2219/00117; B01J 2219/00162; B01J 2219/0018; B01J 2219/00783

(57) ABSTRACT

The present invention relates to plate elements for the construction of a reactor module for carrying out endothermic reactions at high temperatures, the plate elements being designed in such a way that all reactant gases are heated by flowing around heating elements and the reaction zone is heated at the same time. The present invention also relates to reactor modules and reactor systems using the plate elements according to the invention pressed against each other, as well as the corresponding methods for efficiently carrying out endothermic chemical reactions, in particular the rWGS reaction.

### BACKGROUND/STATE OF THE ART

In view of the problems associated with increasing global warming and the reduced availability of fossil fuels, it is becoming increasingly important to find practicable and flexible solutions for converting waste products, such as waste gases, into higher-value hydrocarbon compounds.

A readily and widely available starting product for such conversion is CO₂ in particular. However, in order to render the carbon from CO₂ available for the production of higher-value hydrocarbons, it must first be “activated”, for example by converting CO₂ into carbon monoxide (CO).

With regard to the conversion of CO₂ into CO, various reactors and processes are discussed in the literature. DE 10 2017 120 817, for example, describes a reactor, in which a so-called rWGS reaction (reverse water gas shift reaction) can be advantageously carried out. However, the endothermic rWGS reaction requires high temperatures (typically above 600° C.), also in order to avoid or to minimize disruptive side reactions such as a methane or soot formation. In order to achieve such high temperatures, a considerable amount of energy must be introduced into the system (and/or the energy loss, especially the heat loss, must be minimized). It is also advantageous to use the energy introduced into the system for other (subsequent) processes, i.e. not just the rWGS reaction. Other endothermic high-temperature processes such as an ammonia synthesis also require such thermal/energetic optimization and corresponding reactor modules and reactor systems.

WO 2021/063796 describes reactors for an “on demand” synthesis for a methanol cracking and the rWGS. Here, the reactant gases are passed over structured catalyst zones in which the catalytically active material is deposited on the surfaces of these zones and a corresponding structure of an electrically conductive material is also applied in order to heat the catalyst layer via a resistance heater.

Reactor systems for such conversions, which can be scaled up or down depending on local requirements, and which ideally can be transported from site to site, for example in transportable support frames or containers, are of particular interest when fossil associated and surplus gases are to be processed or converted.

### Object

In light of the prior art, one object of the present invention is, among other considerations, to provide reactors for chemical reactions in which easily scalable approaches can be run.

Another object of the present invention is to optimize the heat balance in endothermic (or only slightly exothermic) reactions.

### Aspects of the Invention

According to a first aspect, the problems underlying the invention are at least partially solved by a plate element for a reactor module for carrying out endothermic reactions, wherein the plate element comprises at least:
at least one first micro- or milli-structured reactant fluid channel for supplying a first reactant fluid, and
at least one second micro- or milli-structured reactant fluid channel for supplying a second reactant fluid which is different from the first reactant fluid, and/or
at least one micro- or milli-structured product fluid channel for discharging one or more product fluids,
wherein optionally at least a first reactant fluid channel and at least a second reactant fluid channel are brought together in a common mixing zone,
wherein the plate element further comprises at least one reaction zone which can be charged with a catalyst,
wherein all fluid channels are materially connected to the at least one reaction zone,
wherein the plate element comprises or may accommodate at least one heating element,
wherein the at least one heating element is in thermal connection with the reaction zone.

In accordance with the present invention, “materially connected” means that a fluid can flow, in principle, unhindered into the connected elements, for example from a channel into a zone or vice versa.

In accordance with the present invention, “thermally connected” or “in thermal communication” means that thermal energy can be transferred by convection, radiation and heat conduction, for example from a heating element to a reaction zone or from a heating element to a reactant fluid.

In embodiments, the at least one heating element in material communication with at least one first reactant fluid channel and/or at least one second reactant fluid channel is thermally connected to the reaction zone, said heating element being spaced from said reaction zone by a minimum common distance of not more than 10 mm, preferably not more than 5 mm, or the end of the heating element furthest downstream in the flow direction is spaced not more than 25 mm, preferably not more than 15 mm, from the reaction zone in the flow direction, or both.

In embodiments, “being in thermal communication” means that heat is transferred by conduction via a plate element from at least one heating element to a reaction zone, or that heat is transferred via heated reactant fluid from a heating element to reaction zone, or both.

In embodiments, “being in thermal communication” means that two regions of a plate element (or a reactor module or of a reactor system) are thermally conductively connected to each other in such a way that the thermal conductivity is from 5 W/mK to 20 W/mK at 20° C., preferably from 8 W/mK to 16 W/mK at 20° C., and more preferably from 10 W/mK to 15 W/mK at 20° C., and/or from 10 W/mK to 50 W/mK at 800° C., preferably from 15 W/mK to 40 W/mK at 800° C., and more preferably from 20 W/mk to 35 W/mK at 800° C. These thermal conductivities in particular allow for an efficient heating of the catalyst even by heating elements not located in the catalyst bed.

This “direct” heating of both the (all) reactant fluids and the reaction zone is advantageous compared to the examples mentioned in the prior art, since lower temperature gradients occur in the reaction zone, and here in particular in the catalyst, the reactant fluids are uniformly brought to the high temperature required for endothermic reaction and suffer only a slight, if any, heat loss in the catalyst.

In accordance with the present invention, “high temperatures” means temperatures from 400° C. to 1500° C., preferably from 500° C. to 1200° C., more preferably from 600° C. to 1100° C., and particularly preferably from 700° C. to 1000° C.

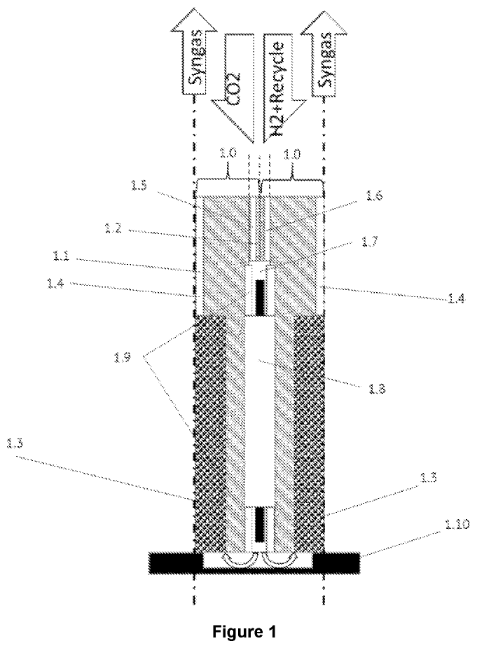

In embodiments of the invention (as illustrated in FIG. 1), the first reactant fluid channel and second reactant fluid channel are brought together in a common mixing zone, with at least one heating element being located in this mixing zone. According to this embodiment, it is preferred that the reactant fluid flows around or through the heating element(s) in direct physical contact.

In accordance with the present invention, “direct physical contact” means that the reactant fluid comes into direct physical contact with at least a part of the heating element, so that the reactant fluid is deflected or redirected by this part of the heating element and/or that a change in the flow properties occurs due to a change in cross-section in the sense of Hagen Poiseuille's law.

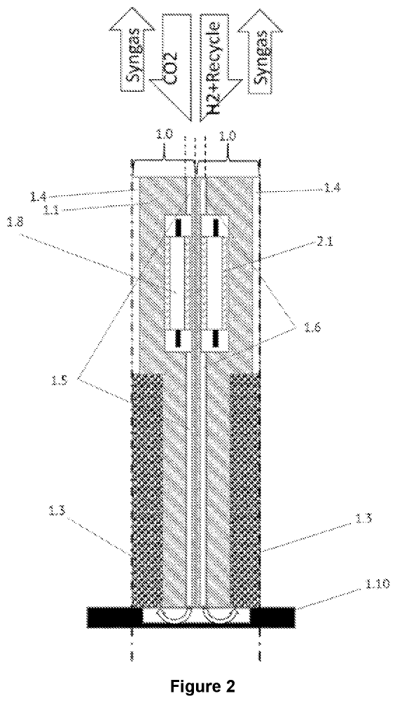

In embodiments of the invention (as illustrated in FIG. 2), the first reactant fluid channel and the second reactant fluid channel each has at least one separately controllable heating element. Also, according to this embodiment, it is preferred that the reactant fluid flows around or through the heating element(s) in direct physical contact.

In embodiments of the invention, the heating element comprises a resistance wire surrounded by a ceramic sheath, the wire preferably being completely surrounded by the ceramic sheath.

In embodiments of the invention, the heating element is connected to the plate element with one element flush with the other element (“form fit”) via at least one high-temperature resistant, preferably flexible, material.

In embodiments of the invention, the high-temperature resistant, preferably flexible, material comprises a fiber material or a felt material, preferably selected from aluminum, zirconium or silicon oxides/hydroxides, or combinations thereof. In embodiments, the high-temperature resistant, preferably flexible, material comprises any or all of these materials.

In accordance with the present invention, “form-fit” means that an outer surface of the heating element is connected to a surface of the plate element via the high-temperature resistant material by interlocking surface structures, so that preferably all three components (the heating element, the high-temperature resistant material and the plate element) are fixed against each other, preferably even in the absence of or an interruption of applied force.

In accordance with the present invention, “high-temperature resistant” means that no physical or chemical changes of the materials occur, which impair the functionality of the plate elements or reactor modules, in particular not at temperatures up to 900° C., up to 1100° C. or up to 1500° C.

In accordance with the present invention, “flexible” means that the material is pliable and elastic, in particular elastic in all three spatial directions.

In embodiments, the plate element comprises at least one electrical connection for operating a heating element, preferably a plurality of such electrical connections, wherein the electrical connection(s) is/are preferably arranged substantially perpendicular to the direction of flow of the reactant and product fluids, wherein preferably all electrical connections are arranged substantially perpendicular to the direction of flow of the reactant and product fluids.

This arrangement of the electrical feedthrough essentially in an orthogonal manner or slightly against the direction of flow of the gases to be heated (i.e. “laterally” protruding with vertically “upright” arranged plate elements) is associated with the advantage that the plates and in particular the channels can be better sealed against each other. Therein, the effect of the static pressure of the flow is at a maximum, but not the dynamic pressure along the feedthrough.

In embodiments of the invention, the at least one heating element is arranged essentially parallel to the reaction zone (see FIG. 1).

In embodiments of the invention, the at least one heating element is arranged substantially perpendicular to the reaction zone.

For the purposes of the present invention, “substantially perpendicular” means an angle of 85° to 95° and “substantially parallel” means an angle of 175° to 185°.

In preferred embodiments, the at least one heating element in material communication with at least one first reactant fluid channel and/or with at least one second reactant fluid channel is thermally conductively connected to the reaction zone, and this heating element is spaced from this reaction zone by a minimum common distance of not more than 10 mm, preferably not more than 5 mm, and/or the heating element is spaced from the reaction zone in the direction of flow by not more than 35 mm, preferably by not more than 25 mm, and more preferably by not more than 15 mm.

In embodiments, the end of a heating element furthest downstream in the direction of flow is no more than 45 mm, preferably 25 mm, and more preferably no more than 15 mm from the start of the reaction zone in the direction of flow.

In embodiments, “being in thermal communication” comprises heat transfer by heat conduction from the heating element to the reaction zone via a plate element, or via the reactant fluid heated by a heating element, or both.

In preferred embodiments, the thermal conductivity of the plate element (averaged over the entire plate element) is from 5 W/mK to 20 W/mK at 20° C., preferably from 8 W/mK to 16 W/mK at 20° C., and more preferably from 10 W/mK to 15 W/mK at 20° C., and/or from 10 W/mK to 50 W/mK at 800° C., preferably from 15 W/mK to 40 W/mK at 800° C., and more preferably from 20 W/mK to 35 W/mK at 800° C. In particular, these thermal conductivities allow for an efficient heating of the catalyst even via heating elements not located in the catalyst bed.

In accordance with the present invention, the “least common distance” is the smallest length that can be measured from any part of the heating element located at the outer periphery to any part of the outer periphery of the reaction zone. Herein, a small distance is synonymous with “good heat transfer”, since the heat input from the heating element to the reaction zone is significantly reduced or the heat losses increase as the distance increases.

According to a second aspect, the problems underlying the invention are at least partially solved by a reactor module for carrying out endothermic reactions at high temperatures, wherein the reaction module comprises at least two plate elements pressed against each other and sealed against each other as described above or as described throughout the present document, preferably at least three or four plate elements, and more preferably exactly three or four plate elements, wherein at least two plate elements are different from each other, in particular with respect to their geometry and/or structure.

In embodiments of the invention, at least two of the plate elements which are pressed against each other and sealed against each other are materially connected to each other by at least two channels common to all plate elements for supplying the reactant fluid, and at least one channel common to all plate elements for discharging product fluid.

In embodiments, at least one heating element, preferably the majority of the heating elements located in the reactor module, and more preferably all heating elements, are each in direct physical contact with the first reactant fluid or the second reactant fluid, or both.

In accordance with the present invention, a “majority” of heating elements is at least half of all heating elements.

In embodiments, at least one heating element, or preferably the majority of the heating elements located in the reactor module, has/have a reactant fluid flowing around and/or through the same in a reactant fluid channel or in a mixing zone, or both.

According to a third aspect, the problems underlying the invention are at least partially solved by a reactor system comprising at least three, preferably at least six, and more preferably at least nine substantially identical reactor modules, as described above or throughout the present disclosure, which are connected in parallel next to each other.

In accordance with the present invention, “substantially identical in construction” means that the reactor modules may have minor deviations, in particular due to manufacturing tolerances, but are the same in terms of function, throughput and other key reactor figures, apart from tolerances.

In embodiments, the heater is preferably operated with rotating current (i.e. three phases). In this context, reactor modules connected in parallel in multiples of “three” within a reactor system are particularly efficient and thus preferred.

In embodiments of the invention, the reactor system comprises a pressure-resistant container in which the reactor modules are arranged materially separate from the environment (i.e. no mass transfer with the environment can take place). Preferably, the reactor modules are arranged essentially perpendicular to the base (i.e. the floor on which the reactor system is located).

In embodiments of the invention, all reactor modules comprise at least two common channels for supplying reactant fluid and at least one common channel for discharging product fluid.

In embodiments of the invention, the pressure-resistant vessel is charged with a reaction gas used in the reactor system, in particular with a water vapor stream or a hydrogen stream, or a mixture of both.

In embodiments of the invention, the pressure-resistant container has a heating system.

According to a fourth aspect, the problems underlying the invention are at least partially solved by a method for carrying out endothermic reactions, in particular at high temperatures, using a reactor system as described above and as described throughout the disclosure.

In embodiments of the invention, the reaction is selected from reforming, in particular methane reforming, ammonia synthesis, ammonia cracking, methanol cracking or reverse water gas conversion (rWGS).

In embodiments of the invention, the first and second reactant fluids are in thermal contact, preferably also in material contact, with different, separately controllable heating elements, and wherein the energy input into the reactant fluid stream via the respective heating element is different.

In embodiments of the invention, the first and second reactant fluids are different from each other, wherein preferably the first reactant fluid substantially contains CO₂, and the second reactant fluid is a H₂-containing fluid.

In embodiments, the pressure-resistant vessel of the reactor system is charged with a reaction gas used in the reactor system, in particular with a water vapor stream or a hydrogen stream, or a mixture of both, wherein the gas stream preferably reaches the catalyst located in the reaction chamber via defined leakages at the feedthrough or feedthroughs to one or more heating elements.

In embodiments, the pressure outside the reactor module and inside the pressure-resistant vessel of the reactor system is greater than in the reaction chambers of the reactor module.

### DETAILED DESCRIPTION

A “plate element” in the sense of the present invention is a three-dimensional body which is defined by two opposing, preferably differently structured cuboidal or square surfaces which are spaced apart from one another, the plate element having a maximum thickness but not necessarily a constant thickness due to the structuring.

The maximum thickness of a plate element is significantly smaller in relation to the lengths of the surfaces, preferably the thickness is less than 1/1000 of the maximum length, preferably less than 1/100.

The plate elements are preferably rectangular, i.e. these are longer (higher) than wide.

In embodiments, the length of a plate element is from 50 cm to 5 m, preferably from 1 m to 3 m, and more preferably from 1 m to 2 m.

In embodiments, the width of a plate element is from 5 cm to 100 cm, preferably from 10 cm to 60 cm, and more preferably from 20 cm to 50 cm.

In embodiments, the thickness of a plate element is from 1 mm to 50 mm, preferably from 2 mm to 30 mm, and more preferably from 3 mm to 20 mm.

In embodiments, the plate element comprises, preferably the plate element consists of, a metal or a metal alloy. Preferably, this alloy is a high-temperature resistant steel. This steel is preferably chemically stable, and in particular resistant to the incorporation of carbon (metal dusting).

Suitable exemplary steels are known as Alloy 800 H/HT, Inconel CA 602, Inconel 693 or under the DIN designations 2.4633 or 1.4876, furthermore Alloy 601, Alloy 690, Alloy 693 and Alloy 699 XA. The steel can also be at least partially provided with an alitization, a water glass coating or a tin coating in order to increase the resistance to metal dusting/soot formation.

A plate element according to the invention has at least three micro- or milli-structured channels which serve to feed or discharge reactant fluids or product fluids into/from a reaction zone.

The characteristic dimension of “micro- or milli-structured” channels in the sense of the invention refers to the “largest cross-sectional length” with which the cross-section of a channel can be described. These channels can have a circular diameter (in which case the largest cross-sectional length is the diameter) or be oval or ovoid, in which case there are at least two characteristic cross-sectional lengths, the larger of which is the “largest cross-sectional length”. In the case of square ducts or ducts with a cuboid cross-section, the largest cross-sectional length is the diagonal.

In embodiments of the present invention, the channels may be incorporated into the plate elements, e.g. milled in. Flow-through cross-sections in the sense of tubes (with an inner diameter and an outer diameter), as are typically used in tube bundle reactors, are preferably not “channels” in the sense of the present invention.

Thus, the channels in the plate elements in the sense of the present invention are not tubes as used in tube bundle reactors.

In embodiments, this “largest cross-sectional length” of a “micro- or milli-structured” channel ranges from 500 μm to 100 mm, preferably from 800 μm to 50 mm, particular preferably from 1 mm to 40 mm, and more preferably from 2 mm to 20 mm.

In embodiments, the channels are arranged side by side and/or on top of each other, and run substantially parallel to each other. The presence of a plurality of channels next to each other (or on top of each other) increases the overall heat transfer within the plate element as well as between the plate elements.

In embodiments, the channels are arranged in and/or between the plate elements according to the invention. In embodiments, the channels are arranged between two plates according to the invention, i.e. the channels are formed by connecting a first plate according to the invention with a second plate according to the invention to form a pair of plates.

The reactant fluid channel and the product fluid channel may be of the same or different geometry/design.

In addition to these reactant fluid and product fluid channels (preferably arranged vertically, i.e. in “upright” plates), the plate elements, in particular when these are joined together to form a reactor module or a reactor system, preferably also contain at least two reactant fluid feed devices, each of which is connected to a reactor module or a reactor system, preferably also at least two reactant fluid feed devices each of which is connected to a reactant source, as well as at least one product fluid discharge device which collects the product fluid and feeds it to further processing (detection, separation, subsequent reaction, in particular Fischer-Tropsch reaction or methanol synthesis).

Both the reactant fluid feed devices and the product fluid discharge device are preferably arranged perpendicular to the micro- and milli-structured reactant fluid or product fluid channels, and extend parallel to the bottom (see “end plate” (1.10) in FIG. 1) on which the device is built or parallel to the stacking direction of a stack of plates according to the invention (reactor module, reactor system).

Preferably, both reactant fluid supply devices and product fluid discharge devices are arranged via through-holes at a first and/or second end of a plate according to the invention.

The sealing of both the reactant fluid supply device and the product fluid discharge device against unwanted or uncontrolled leakage of reactant fluid and/or product fluid can be achieved by temperature-resistant O-rings (temperatures up to approx. 300° C. are possible), by mica seals or by weld ring seals. Similarly, the plates can also be sealed against each other as such.

In embodiments, a plate element according to the invention has both reactant fluid channels and product fluid channels on one surface.

In embodiments, a plate element according to the invention exclusively has reactant fluid channels, whereas another plate element exclusively has product fluid channels, or a plate element has exclusively reactant fluid channels or product fluid channels.

In embodiments, in particular when the reaction to be carried out in the plate element is a rWGS reaction, at least one reactant fluid is a fluid comprising or consisting essentially of CO₂. At least one further reactant fluid is then a fluid comprising or consisting of H₂. The CO₂ reactant fluid and the H₂ reactant fluid are fed to the reaction zone in separate, distinct reactant fluid channels and are not mixed until they enter this zone, which comprises a catalyst during operation.

In embodiments, the product fluid comprises CO. Furthermore, the product fluid may comprise one or more fluid(s) selected from CO₂, H₂, CH₄ or mixtures thereof.

A plate element according to the invention has at least one reaction zone which can be charged with a catalyst or which is charged with a catalyst, in particular a catalyst fixed-bed charge, during operation. In embodiments, the catalyst is suitable for promoting the conversion of carbon dioxide (CO₂) and hydrogen (H₂) to carbon monoxide (CO) and water (H₂O). This conversion is referred to as a reverse water gas shift (rWGS).

In embodiments, the fixed bed catalyst essentially consists of particles having an average diameter from 500 μm to 5 mm, and preferably from 1 mm to 3 mm.

In embodiments, the reaction zone is essentially arranged on that side of a plate element which is opposite to the side of the plate element which forms the reactant fluid and product fluid channels, optionally in interaction with further plates of a reactor module.

In embodiments, this reaction zone extends over at least 50%, preferably at least 80% of the width on this one side of the plate element, as well as over a maximum of 30% of the total length of the plate element, and preferably over a maximum of 20% of the length.

In embodiments, the reaction zone is arranged substantially parallel to the direction of flow of the reactant and product fluids.

Preferably, the reaction zone has a length (“height” if the plate element, as it is preferred, is arranged “upright” or vertically) of from 5 cm to 50 cm, preferably from 10 cm to 30 cm, and more preferably from 12 cm to 25 cm.

The reaction, in particular an endothermic reaction, and in particular an rWGS reaction, takes place in the reaction zone. The reaction zone is therefore heated to temperatures of at least 650° C., preferably at least 700° C., preferably from 600° C. to 1500° C. or 1100° C., more preferably from 700° C. to 1000° C., particularly preferably from 700° C. to 900° C., and more preferably from 720° C. to 780° C., by means of a thermal connection to the heating elements according to the invention, and to the preheated reactant fluids.

In embodiments, there are no heating elements in the reaction zone itself.

In embodiments, the reaction zone is heated to the temperature required for carrying out an endothermic reaction exclusively via the preheated reactant fluids and by thermal contact with the heating elements also provided for heating the reactant gas.

A plate element according to the invention, in particular plate elements according to the invention in a reactor module, have at least one heating element which is in thermal contact with the at least one first reactant fluid channel or the at least one second reactant fluid channel, as well as the reaction zone.

By “heating element” in the sense of the present invention a device is meant which is suitable for transferring thermal energy from the heating element to the fluids flowing in the reactant fluid channels and into a reaction zone. For this purpose, the heating element must be in thermal contact with the fluids flowing in the reactant fluid channels and the reaction zone. The thermal energy can be transferred via conduction, radiation and convection. Preferably, the reactant fluids are heated to temperatures from 400° C. to 1500° C. or to temperatures from 720° C. to 1100° C., and preferably from 750° C. to 900° C.

The heating element preferably comprises a resistance wire which heats up according to Ohm's law when an electric current flows through it.

The resistance wire is further preferably encased in a ceramic sheath, at least partially, and preferably completely, wherein the cross-section (a diameter or a largest length in the cross-section) is 2 to 8 mm, and preferably 3 to 6 mm.

In embodiments, the length of the heating element is from 5 cm to 40 cm, and preferably from 10 cm to 20 cm. The structure of such a heating element is described by way of example in the U.S. Pat. No. 9,867,232. Preferred heating elements of this type are so-called “flow heaters”.

Preferably, the at least one heating element is connected to the plate element according to the invention in “form-fit” manner and via at least one high-temperature resistant, preferably flexible, material.

In embodiments, the flexible material is a fiber mat that can be compacted by a factor of 2 to 5 without a force from the outside being noticeably transmitted to the ceramic of the heating element.

The high-temperature resistant, preferably flexible, material is preferably selected from Al₂O₃ and/or mica. Preferably, the high-temperature resistant, flexible material is realized as a fiber mat or a fleece. The thickness of the fiber mat or the fleece is preferably less than 1 mm.

The at least one heating element is at least partially, and preferably completely, enclosed by a high-temperature resistant, preferably flexible, material. This is associated with the advantage that the material can thus also act as a breakdown protection against voltage flashovers in the event of breakage of the ceramic sheath of the resistance wire of the heating element.

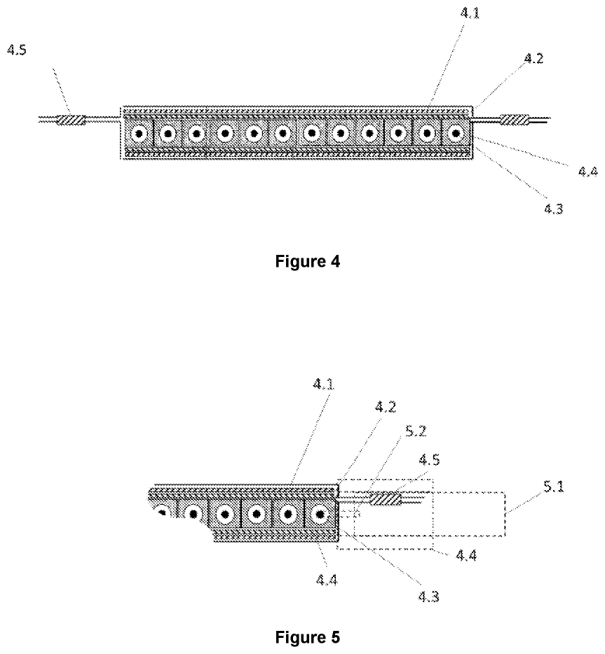

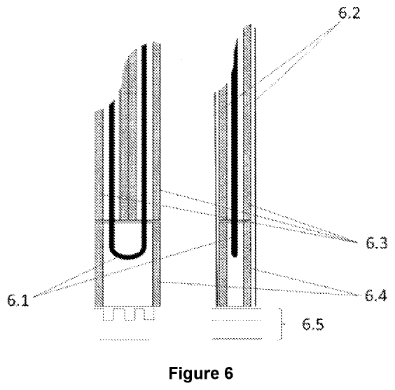

Preferably, the high-temperature resistant, preferably flexible material is arranged on both sides, in a parallel arrangement, around one or more heating elements (see FIGS. 4 and 5). The connection to the plate element according to the invention is preferably achieved by pressing.

The at least one heating element can furthermore be equipped with at least one support device. The support device extends essentially parallel to the heating element and is in direct material contact with the ceramic of the heating element or consists of the same material (see FIG. 6).

The plate element according to the invention also has electrical connections for operating the at least one heating element.

The electrical connections preferably emanate laterally, vertically (i.e. not in the direction of flow of the reactant fluids and product fluids) from the plate element according to the invention, and preferably on the outlet side of the heating element (see FIGS. 4 and 5).

In embodiments, the cross-section of the resistance wire is enlarged towards the area around which the reactant fluid flows to the connections, i.e. the areas around which the reactant fluid does not flow, in order to avoid thermally induced breakage of the resistance wire.

The increase in cross-section is preferably achieved by a thickening wire or by two twisted wires.

As the cross-section of the resistance wire increases, the diameter of the heating element as a whole, including the surrounding ceramic, is increased. Thus, the lead-through from the plate elements can also be adapted to this increased diameter.

In embodiments, the feedthrough is preferably arranged to emanate out of the plate elements in a plane with the heating element, around which the reactant fluid flows. This has the advantage of compensating for a change in length of the resistance wire during current flow/heating and avoiding a voltage flashover.

Preferably, the plate element has slots on the sides through which electrical connections can be made.

Preferably, the at least one heating element (or the majority of heating elements) is arranged substantially parallel to the reaction zone (see FIG. 1). This arrangement has the advantage that the thermal contact between the heating element and the reaction zone can be maximized. In particular, the thermal energy is transferred “directly” by heat conduction through a comparatively thin and solid wall (i.e. without unnecessary or significant heat sinks) via the plate element according to the invention directly into the reaction zone. Furthermore, heat is also introduced into the catalyst bed via the heated reactant fluid. Thus, the temperature in the catalyst bed can be maximized, which is particularly advantageous for endothermic reactions in the catalyst bed.

This embodiment is explained in more detail below in FIG. 1:
a pair of plates (1.0),
a first plate element (1.1),
a second plate element (1.2),
a reaction zone which can be charged with a catalyst (1.3) [inserted in plate 1 or the plate 4],
a product fluid channel (1.4), which discharges a product fluid from the 1.3,
a first reactant fluid channel (1.5) which feeds a first reactant fluid to the zone (1.3),
a second reactant fluid channel (1.6), which feeds a second reactant fluid to the zone (1.3),
a mixing zone (1.7) in which both reactant fluid flows from the reactant fluid channels (1.5) and (1.6) are combined,
a heating element (1.8),
a support device (1.9), which is arranged at a distance from the heating element (1.8) in the mixing zone (1.7),
an end plate (1.10), which closes the pair of plates at one end so that the combined reactant fluid flow is diverted into the reaction zones (1.3).

As shown in FIG. 1, the at least one heating element is arranged essentially at the level of the reaction zone, preferably starting above the reaction zone or starting with the exit from the reaction zone. This has the advantage that the heat transfer from the heating element to the reaction zone is uniform over the length of the reaction zone and that the catalyst cannot cool down unhindered, which can lead to side reactions, for example methane formation.

FIG. 2 shows an alternative embodiment which essentially corresponds to the embodiment of FIG. 1, with the difference that the two different reactant fluids (e.g. CO₂ and H₂ in the mixture) are also heated in separate channels to the temperature required for the reaction in each case, namely by flowing around/through the heating elements. This has at least two advantages. On one hand, in this embodiment, the different reactant fluids can also be heated separately and in a targeted manner (different fluids require different heat input in order to be “brought” to the temperature required for the reaction). On the other hand, the reactant fluids can be fed s″eparately until they reach the reaction zone and are only mixed together in the reaction zone. This is advantageous for reactions such as rWGS, since heated reactant fluids already may react with each other, which can lead to a soot formation on the inner walls of the reactant fluid channels, among other things.

The reference signs in FIG. 2 correspond to the reference signs in FIG. 1 with the addition that (2.1) denotes fiber mats which “elastically” protect the heating elements against breakage of the ceramic due to thermal expansion during operation.

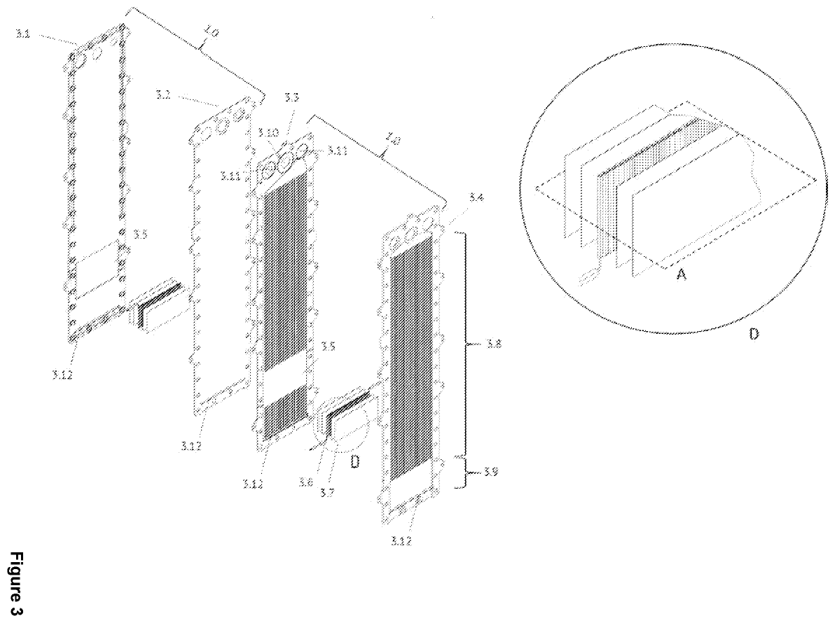

FIGS. 3 to 5 show an embodiment with a focus on the arrangement of the heating elements through and around which the reactant fluid flows in a mixing zone, which in this case are arranged in a linear array.

FIG. 3 is an exploded view of four plates (3.1) to (3.4) (a first, a second, a third and a fourth plate element) as shown in cross-section in FIG. 2 with recesses (3.5) for the heating elements. The corresponding array of heating elements used is (3.6), whereby the heating elements (see detail D) are protected against breakage of the ceramic by thermal expansion of the plate elements by fiber mats (3.7) arranged on both sides. In plate (3.4), (3.8) designates the product fluid channels. (3.9) denotes the reaction zone, in this case a recess filled with fixed-bed catalyst. The reactant fluid channels are located on plate elements 3.3 and 3.2 (not visible in the figure, as these are on the opposite side of the plate element). The reactant fluids enter the reaction zone (3.9) through deflection slots 3.12 (see also FIG. 2). Here, (3.11) is the reactant fluid feed device and (3.10) is the product fluid discharge device.

Section (A) in FIG. 3 is shown in FIGS. 4 and 5. There, (4.1) is a layer of mica, which acts as a breakdown protection in the event of breakage of the ceramic (4.4). As already explained above, the fiber mat (4.2) serves to protect the ceramic against breakage. (4.3) refers to the heating wire. Finally, (4.5) denotes a mica seal in the groove between two plates. The corresponding reference signs also apply to FIG. 5, with the addition that electrical connections are shown here, in particular bolts (5.1) and a weld (5.2) between the heating wire and the bolt.

Finally, FIG. 6 shows a support element (6.4), in two different sectional perspectives rotated by 90°, each of which protects two ceramics (6.3) in pairs and a heating wire with a wire bend (6.1) located therein. Here, (6.2) shows the boundary walls through the two plate elements. (6.5) shows the base plate with channels in the stacking direction for deflecting the gases and for supporting support elements (6.4) and the catalyst bed.

The plate element according to the invention furthermore may comprise at least one heat recuperation zone. In this zone, a heat transfer preferably takes place from the hot product fluid to the reactant fluids guided in a countercurrent.

This recuperation zone is preferably located above the reaction zone, in particular in the case of “standing plates”. This heat recuperation between the product fluid and the reactant fluid is also advantageously increased compared to prior art examples (for example, compared to tubular reactors) by the fact that a particularly good heat exchange can take place in channels of a plate element, as less thermal resistance has to be overcome than, for example, in a tubular bundle reactor, in which the diameter and spacing of the tubes require a turbulent flow in order to maximize the heat transfer coefficients at the wall, or the wall thickness of the tubes must be greater than the thickness of the plate separating the channels. In the channels, the heat transfer coefficient increases reciprocally with reduced height of the channels due to the laminar flow.

In embodiments, in these recuperation zones, a preheating or a heating of the reactant fluids to 400° C. and more, preferably to 600° C. and more, and more preferably to 700° C. and more, is achieved before the reactant gases are brought to the final temperature before entering the reaction zone with the aid of the heating elements according to the invention.

In embodiments, this heat recuperation zone (for the heat exchange between the product fluid and the reactant fluid) is arranged upstream (in the direction of flow of the reactant fluids) of the heating elements, preferably at least 10 cm upstream of the furthest upstream end of the heating element, and more preferably at least 20 cm or 50 cm.

In a further aspect, the present invention relates to a reactor module for carrying out an endothermic high-temperature process, wherein the reactor module comprises at least two plate elements according to the invention as described above and throughout the disclosure, preferably at least three or four plate elements, and more preferably exactly four plate elements.

Preferably, the reactor comprises at least one pair of plate elements, or a stack of plate elements or a stack of pairs of plate elements. To build up such stacks, a first plate element is pressed against a second plate element by means of a circumferential seal comprising, for example, mica. This process is repeated until the desired stack size is reached and a reactor module is built up.

Preferably, the first plate element comprises reactant fluid channels and the second plate element comprises product fluid channels. This has the advantage that the flow of reactant fluid(s) through the heating element is thus ensured. In addition, the unwanted discharge of reactant fluid from the plate stack is prevented.

The sealing of the plates (e.g. via mica) also acts as a compensating element for any different degrees of material expansion that may occur due to temperature gradients occurring in the stack or in the pair of plates.

In embodiments, the seal is “reversible”, i.e. it can be broken without destroying a plate element. This makes it easy to dismantle the stack or the pair of plates for maintenance or repair purposes.

In further embodiments, at least two reactor modules according to the invention are connected in parallel to form a reactor system as described above and throughout the application as a whole, so that the throughput can be scaled up and down as desired-within technically reasonable limits.

Preferably, at least three or at least six or nine reactor modules are connected in parallel.

The reactor system preferably also comprises a pressure-resistant container in which the reactor modules or the stack of plate elements or the pairs of plate elements can be operated without mass transfer with the environment. This is associated with the advantage that the electrical connections for the at least one heating element, which are led out of the plate element, do not have to be completely sealed, and a leaking reactant fluid or leaking reactant fluids can be collected.

The reactor modules are preferably attached via a suspension. A suspension (at the comparatively cool upper end) is advantageous because the hot areas of the plate elements are thus not thermally conductively connected to the outer housing.

In embodiments, the pressure-resistant container is pressurized with a purge gas, in the case of an rWGS with hydrogen. This has the advantage that any reactant fluids that may have escaped from a reactor module can be “flushed” back into the stack. The proportion of the purge gas can be included in the reactant fluid composition if the purge gas participates in the endothermic high-temperature process.

The vessel may be made of stainless steel.

The container may also be equipped with internal heating. This has the advantage that, for example, water vapor which could be present in or added to a reactant fluid does not condense out on the walls of the container.

The container also may comprise feedthroughs for electrical connections. These feedthroughs are flooded with an inert gas, preferably nitrogen. This has the advantage that leaks can be detected, e.g. by means of appropriate sensors, and ignitions at the electrical connections can be avoided.

The variable (scalable) structure of the reactor modules and systems according to the invention with the plate elements as well as the variable stack height, which is defined by the number of plate elements according to the invention, has the advantage that different module sizes of the reactor system according to the invention can be set up quickly and predictably (in respect to throughput).

In embodiments, each plate element according to the invention has the same number of reactant fluid channels and product fluid channels in the reactor according to the invention. Thus, it is possible to obtain a direct correlation of throughput and stack height.

Further according to the invention is a method for carrying out endothermic high-temperature processes using the reactor module or reactor system according to the invention as described above.

Further according to the invention is the use of the reactor according to the invention for carrying out endothermic high-temperature processes, preferably selected from reforming reactions, in particular a methane reforming, an ammonia synthesis, an ammonia cracking, a methanol cracking or a reverse water gas conversion (rWGS), wherein carrying out an rWGS is particularly preferred.

### EXAMPLES

A reactor system according to the invention was constructed from 6 identical reactor modules as shown in FIG. 2. The plate elements essentially consist of the alloy 2.4633 (high-temperature chemically resistant nickel-chromium-iron alloy). The reactor system was operated with the operating parameters according to the following table. The reactor was filled with a total of 1 kg of nickel-based catalyst.

| | | |
|---|---|---|
| CO₂ | 452 | l/min (at standard conditions |
| H₂ total | 377 | l/min (at standard conditions) |
| H₂ over container | 30 | l/min (at standard conditions) |
| H₂O/CO₂ | 0.9 | — |
| H₂O | 406.8 | l/min (gaseous at standard conditions) |
| pressure | 21.8 | bar absolute |
| average value | 795 | ° C. |
| heating wire temperature | | |

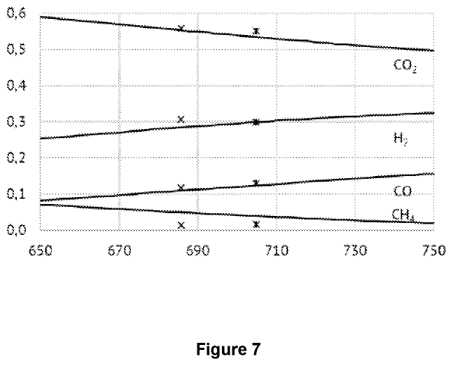

FIG. 7 shows the values measured in this reactor system for the volume fractions of the gases (y-axis) in relation to the mean reaction temperature in the catalyst bed (x-axis). Crosses mark the measured value of the components CO₂, H₂, CO and CH₄ (from top to bottom) in relation to the thermodynamically expected volume fraction (shown as lines). As can also be seen from the following table, the proportion of unwanted methane (side reactions) in the reactor system according to the invention is significantly lower than expected based on thermodynamic calculations, due to the improved heat balance. At the same time, the proportion of desired CO is higher than the calculated value.

| | 685° C. catalyst bed temperature | | 705° C. catalyst bed temperature | |
|---|---|---|---|---|
| | experiment | thermodynamic | experiment | thermodynamic |
| | vol.-% | vol.-% | vol.-% | vol.- % |
| CO₂ | 56.02 | 55.24 | 55.26 | 53.54 |
| CO | 11.82 | 11.15 | 13.10 | 12.49 |
| CH₄ | 1.50 | 4.91 | 1.53 | 3.96 |
| H₂ | 30.67 | 28.70 | 30.10 | 30.02 |

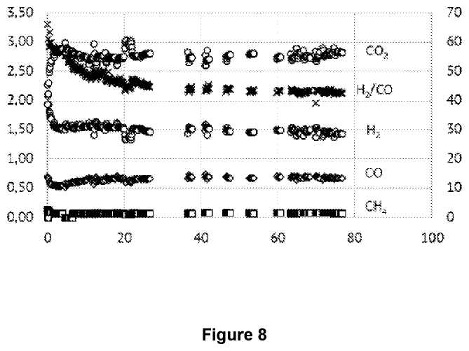

FIG. 8 shows measured values of the volume proportion in percent (right y-axis) for CO₂, H₂, CO, CH₄ and the H₂/CO ratio (left y-axis) as a function of the operating time in hours (x-axis). In the first 2 h, the heating phase is shown, during which the concentration ratios first develop. Seemingly missing data in certain time ranges are due to the fact that the detector units measured product concentrations of the downstream Fischer-Tropsch synthesis in these time ranges.

1. A plate element for a reactor module for carrying out endothermic reactions at high temperatures, the plate element comprising at least:
at least one first micro- or milli-structured reactant fluid channel for supplying a first reactant fluid, and
at least one second micro- or milli-structured reactant fluid channel for supplying a second reactant fluid which is different from the first; and/or
at least one micro- or milli-structured product fluid channel for discharging one or more product fluids, wherein the plate element further comprises at least one reaction zone which can be charged with a catalyst,
wherein all fluid channels are materially connected to the at least one reaction zone,
wherein the plate element comprises or may accommodate at least one heating element, and
wherein the at least one heating element is in thermal connection with the reaction zone.

2. The plate element according to claim 1, wherein at least a first reactant fluid channel and at least a second reactant fluid channel are brought together in a common mixing zone, and at least one heating element is located in said mixing zone.

3. The plate element according to claim 1, wherein a first reactant fluid channel and a second reactant fluid channel, each separately, each contains at least one separately controllable heating element.

4. The plate element according to claim 1, wherein the heating element comprises a resistance wire surrounded by a ceramic sheath, preferably completely surrounded by a ceramic sheath.

5. The plate element according to claim 1, wherein the heating element is connected to the plate element in a “form-fit” manner via at least one high-temperature resistant, preferably flexible, material.

6. The plate element according to claim 5, wherein the high-temperature resistant, preferably flexible, material comprises a fiber material or a felt material, preferably selected from aluminum, zirconium or silicon oxides/hydroxides, or combinations thereof, or consists of these or one of these materials.

7. The plate element according to claim 1, wherein the plate element comprises at least one electrical connection for operating a heating element, preferably a plurality of such electrical connections, wherein the electrical connection is preferably arranged substantially perpendicular or opposite to the direction of flow of the reactant and product fluids, wherein preferably all electrical connections are arranged substantially perpendicular or opposite to the direction of flow of the reactant and the product fluids.

8. The plate element according to claim 1, wherein the at least one heating element is arranged substantially parallel to the reaction zone.

9. The plate element according to claim 1, wherein the at least one heating element is arranged substantially perpendicular to the reaction zone.

10. The plate element according to claim 1, wherein the at least one heating element in material communication with at least one first and/or with at least one second reactant fluid channel is thermally connected to the reaction zone, and wherein said heating element is separated from this reaction zone over a smallest common distance of not more than 10 mm, preferably not more than 5 mm, or the end of a heating element located furthest downstream in the direction of flow is not more than 35 mm, preferably not more than 25 mm, and more preferably not more than 15 mm, away from the reaction zone in the direction of flow, or both.

11. The plate element according to claim 10, wherein said thermal connection comprises that heat is transferred from the heating element to the reaction zone by heat conduction via a plate element, or via the heated reactant fluid, or both.

12. The plate element according to claim 1, wherein the thermal conductivity of the plate element is from 5 W/mK to 20 W/mK at 20° C., preferably from 8 W/mK to 16 W/mK at 20° C., and more preferably from 10 W/mK to 15 W/mK at 20° C. and/or from 10 W/mK to 50 W/mK at 800° C., preferably from 15 W/mK to 40 W/mK at 800° C., and more preferably from 20 W/mK to 35 W/mK at 800° C.

13. A reactor module for carrying out endothermic reactions at high temperatures, the reaction module comprising at least two plate elements which are pressed against one another and sealed against one another in accordance with at least one of the preceding claims, preferably at least three or four plate elements, and more preferably exactly three or four plate elements, at least two plate elements being different from one another.

14. The reactor module according to claim 13, wherein at least one heating element, preferably the plurality of the heating elements located in the reactor module are each in direct physical contact with the first reactant fluid or the second reactant fluid, or both.

15. The reactor module according to claim 13, wherein at least one heating element, preferably the plurality of heating elements located in the reactor module in a reactant fluid channel or in a mixing zone, or in both, are flowed around and/or flowed through by reactant fluid.

16. The reactor module according to claim 13, wherein at least two of the plate elements pressed together and sealed against each other are materially connected to each other by at least two channels common to all plate elements for the supply of reactant fluid and at least one channel common to all plate elements for the discharge of product fluid.

17. A reactor system comprising at least three, preferably at least six, more preferably at least nine, and particularly preferably integer multiples of “three”, substantially identical reactor modules according to claim 13.

18. The reactor system according to claim 17, wherein the reactor system comprises a pressure-resistant container in which the reactor modules are arranged in a manner separated from the environment, preferably substantially perpendicular to the standing surface.

19. The reactor system according to claim 17, wherein all reactor modules comprise at least two common channels for supplying reactant fluid and at least one common channel for discharging product fluid.

20. The reactor system according to claim 17, wherein the pressure-resistant vessel is charged with a reaction gas used in the reactor system, in particular with a water vapor stream or a hydrogen stream, or a mixture of both.

21. The reactor system according to claim 17, wherein the pressure-resistant vessel is equipped with a heating system.

22. A method for carrying out endothermic reactions, preferably at high temperatures, using a reactor system according to claim 17.

23. The method according to claim 22, wherein the reaction is selected from reforming reactions, in particular methane reforming, ammonia synthesis, ammonia cracking, methanol cracking or reverse water gas conversion (rWGS), preferably a rWGS.

24. The method according to claim 22, wherein a first reactant fluid and a second reactant fluid are in thermal contact with different, separately controllable heating elements and the energy input into the reactant fluid stream via the respective heating element is different.

25. The method according to claim 22, wherein the first reactant fluid and the second reactant fluid are different from each other, wherein preferably the first reactant fluid is a substantially CO2-containing fluid, and the second reactant fluid is a H2-containing fluid.

26. The method according to claim 22, wherein the pressure-resistant vessel of the reactor system is charged with a reaction gas used in the reactor system, in particular with a water vapor stream or a hydrogen stream, or a mixture thereof, and wherein the gas stream reaches the catalyst located in the reaction chamber via leakages at the feedthrough or the feedthroughs to one or more heating elements.

27. The method according to claim 26, wherein the pressure outside the reactor module and inside the pressure-resistant vessel of the reactor system is greater than in the reaction chambers of the reactor module.
